(19) United States
(12) Patent Application Publication
(10) Pub. No.: US 2002/0124015 A1
(43) Pub. Date: Sep. 5, 2002

(54) Method and system for matching data

(76) Inventors: Andrew John Cardno, Wellington (NZ); Nicholas John Mulgan, Wellington (NZ)

Correspondence Address: David E. Bruhn, DORSEY & WHITNEY LLP, Suite 1500, 50 South Sixth Street, Minneapolis, MN, 55402-1498, US

(21) Appl. No.: 10/061,748

(22) Filed: Feb. 1, 2002

Related U.S. Application Data
(63) Continuation of application No. PCT/NZ00/00148, filed on Aug. 3, 2000.

(30) Foreign Application Priority Data
Aug. 3, 1999 (NZ) 337019

(51) Int. Cl. G06F 12/00; G06F 17/30

(52) U.S. Cl. 707/204; 707/200

(57) ABSTRACT

The present invention provides a method of matching data sets including the steps of Maintaining one or more user data sets in a user data memory, maintaining one or more reference data sets in a reference data memory, retrieving a user data set from the user data memory, retrieving one or more reference data sets from the reference data memory, the one or more retrieved reference data sets matching or partially matching the user data set, and compiling a list of candidate reference data sets from the one or more retrieved reference data sets.

### FIELD OF INVENTION

The invention relates to a method and system for matching data sets. The invention is particularly suitable for matching street address data in a user database with street address data in a reference database.

### BACKGROUND TO INVENTION

The low cost of mass data storage allows organisations to generate and collect large volumes of data during the course of their operations. One example of this data storage is a customer list maintained by a merchant. Street addresses and other data about customers are generally manually entered into a customer database maintained by the merchant.

To compete effectively with other merchants, it is desirable for the merchant to be able to identify and use information hidden in collected data such as the customer database. One method often available to a merchant is geocoding. Also known as location coding, geocoding is the technique of assigning geographic coordinates, for example latitude and longitude coordinates to individual stress addresses in a database. These geographic coordinates are often obtained from a reference database which contains street addresses and corresponding geographic coordinates.

Once the geographic coordinates of the customers of a merchant are known, the merchant can use this geographic information to identify demographic characteristics of the customers, for example psychodynamic or psychographic data. Once the demographic characteristics of the customers of a merchant are known, the merchant can target advertising and other services more effectively.

One difficulty faced with previous geocoding techniques, and indeed any organisation maintaining a database compiled largely from manual entries, is that the data is often incomplete or contains errors. Where the address data contains errors it is difficult to match addresses in the organisation's database with addresses in the reference database. This means that geocoding techniques in the past have required significant manual input to geocode the data.

### SUMMARY OF INVENTION

In broad terms in one form the invention comprises a method of matching data sets comprising the steps of maintaining one or more user data sets in a user data memory, each user data set comprising one or more user data items; maintaining one or more reference data sets in a reference data memory, each reference data set comprising one or more reference data items; retrieving a user data set from the user data memory; retrieving one or more reference data sets from the reference data memory, each of the retrieved reference data sets matching or partially matching the user data set; and compiling a list of candidate reference data sets from the retrieved reference data set(s).

In another form in broad terms the invention comprises a data set matching system comprising one or more user data sets maintained in a user data memory, each user data set comprising one or more user data items; one or more reference data sets maintained in a reference data memory, each reference data set comprising one or more reference data items; user data set retrieval means arranged to retrieve a user data set from the user data memory; reference data set retrieval means arranged to retrieve one or more reference data sets from the reference data memory, each of the retrieved reference data sets matching or partially matching the user data set; and compiling means arranged to compile a list of candidate reference data sets from the retrieved reference data set(s).

In a further form in broad terms the invention comprises a data set matching computer program comprising one or more user data sets maintained in a user data memory, each user data set comprising one or more user data items; one or more reference data sets maintained in a reference data memory, each reference data set comprising one or more reference data items; user data set retrieval means arranged to retrieve a user data set from the user data memory; reference data set retrieval means arranged to retrieve one or more reference data sets from the reference data memory, each of the retrieved reference data sets matching or partially matching the user data set; and compiling means arranged to compile a list of candidate reference data sets from the retrieved reference data set(s).

### BRIEF DESCRIPTION OF THE FIGURES

Preferred forms of the method and system for matching data sets will now be described with reference to the accompanying figures in which:

FIG. 1 shows a block diagram of a system in which one form of the invention may be implemented;

FIG. 2 shows the preferred system architecture of hardware on which the present invention may be implemented;

FIG. 3 is an example of a sample reference database;

FIG. 4 is an example of a sample user database;

FIG. 5 illustrates a method of compiling a list of candidates based on matches and partial matches;

FIG. 6 shows the abbreviation table of FIG. 1;

FIG. 7 illustrates different rules stored in the rule base of FIG. 1 for obtaining partial matches; and

FIGS. 8A and 8B are examples of sample entries in the neighbour table of FIG. 1.

### DETAILED DESCRIPTION OF PREFERRED FORMS

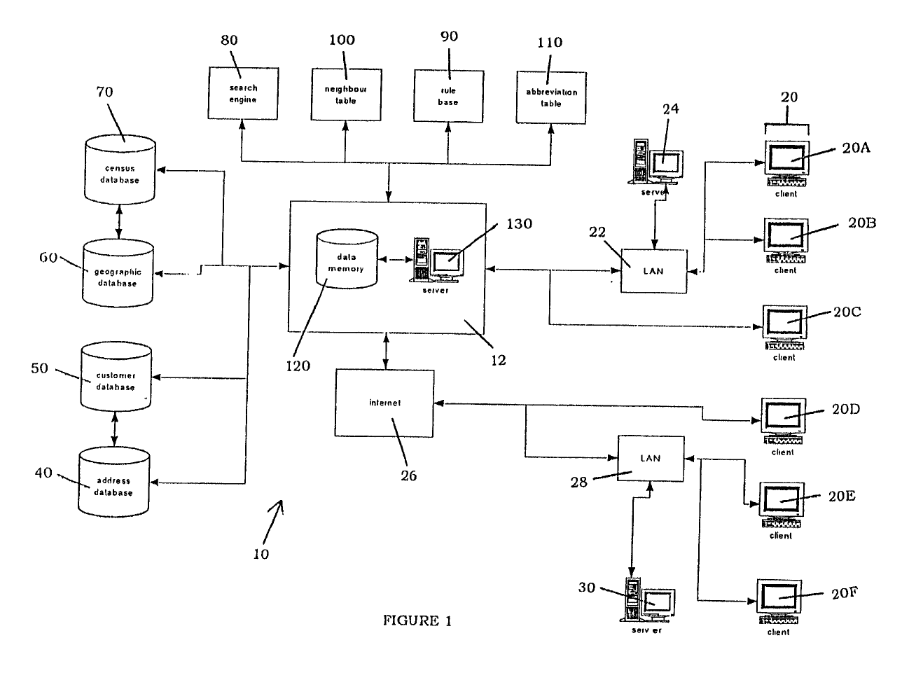

FIG. 1 illustrates a block diagram of the preferred system 10 in which one form of the present invention 12 may be implemented. The system includes one or more clients 20, for example 20A, 20B, 20C, 20D, 20E and 20F, which each may comprise a personal computer or workstation described below. Each client 20 is interfaced to the invention 12 as shown in FIG. 1.

Each client 20 could be connected directly to the invention 12, could be connected through a local area network or LAN, could be connected through the Internet, or could be connected through a suitable wireless application protocol or WAP. Clients 20A and 20B, for example, are connected to a network 22, such as a local area network or LAN. The network 22 could be connected to a suitable network server 24 and communicate with the invention 12 as shown. Client 20C is shown connected directly to the invention 12. Clients 20D, 20E and 20F are shown connected to the invention 12 through the Internet 26. Client 20D is shown connected to the Internet 26 with a dial-up connection and clients 20E and 20F are shown connected to a network 28, such as a local area network or LAN, with the network 28 connected to a suitable network server 30.

The preferred system 10 further comprises one or more user databases. The user databases could include, for example, an address database 40 and/or a customer database 50. The customer database 50 could be connected to the address database 40 and/or to the invention 12. The user databases such as the address database 40 and customer database 50 are generally databases which have been compiled manually and often contain errors and omissions.

The system 10 further comprises one or more reference database. The reference databases could include, for example, a geographic database 60 and/or a census database 70. The census database 70 could be connected to the geographic database 60 and/or to the invention 12. The reference databases are generally databases which are compiled from official sources. These reference databases tend to comprise reference data stored in a consistent form with few errors.

The system 10 may further comprise search engine 80, rule base 90, neighbour table 100 and abbreviation table 110. These components are more particularly described below.

One preferred form of the invention 12 comprises a personal computer or workstation operating under the control of appropriate operating and application software, having a data memory 120 connected to a server 130. The invention is arranged to retrieve data from the user databases 40 and 50 and the reference databases 60 and 70, process this data with the server 130, display the data on a client workstation 20 and/or store data in the databases 40, 50, 60 and 70.

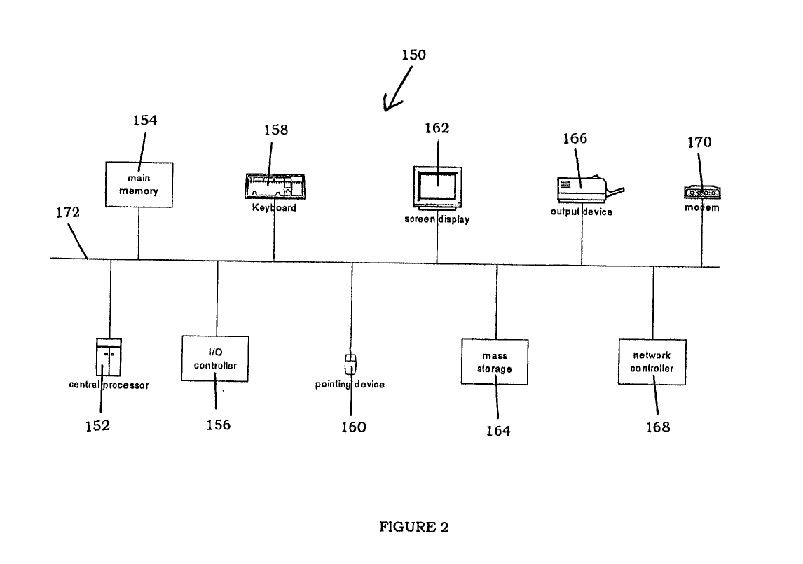

FIG. 2 shows the preferred system architecture of a client 20 or invention 12. The computer system 150 typically comprises a central processor 152, a main memory 154 for example RAM and an input/output controller 156. The computer system 150 also comprises peripherals such as a keyboard 158, a pointing device 160 for example a mouse, track ball or touch pad, a display or screen device 162, a mass storage memory 164 for example a hard disk, floppy disk or optical disc, and an output device 166 for example a printer. The system 150 could also include a network interface card or controller 168 and/or a modem 170. The individual components of the system 150 could communicate through a system bus 172.

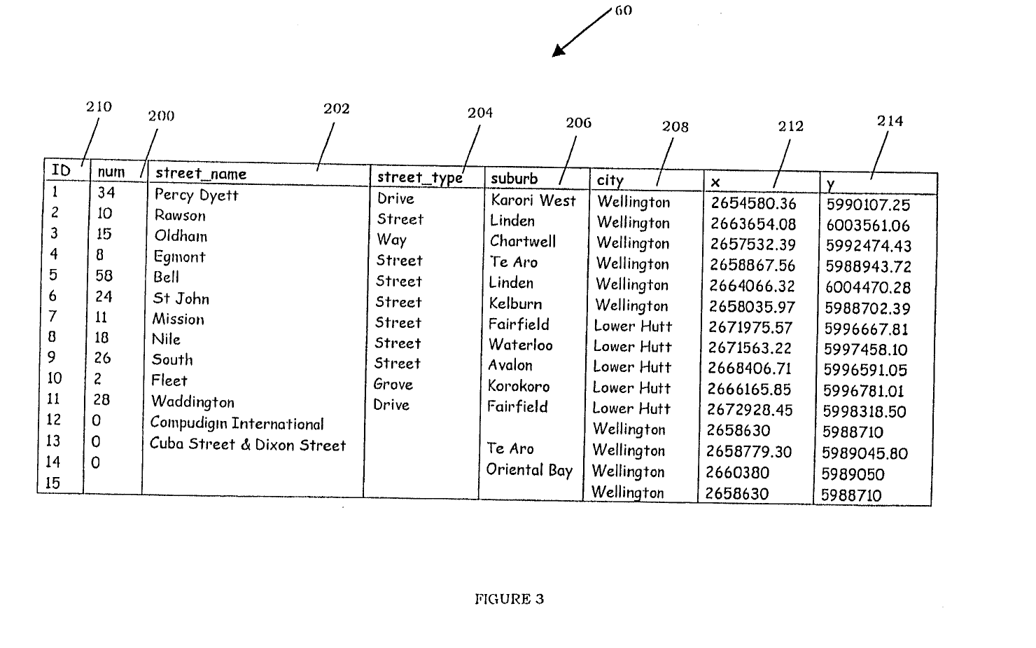

FIG. 3 shows a sample reference database in the form of a geographic database 60. Reference databases which are not geographic databases are within the scope of the invention. The geographic database 60 is simply one preferred form of reference database. The reference data sets stored in the geographic database may be compiled from a number of official sources for example geocoding streets files maintained by Statistics New Zealand, MDS, Terralink or other organisations.

The geographic database 60 may be implemented using a number of different products, for example, Oracle, Sybase, Informix, DB2, Microsoft SQL Server, or Microsoft Access. The geographic database 60 as shown in FIG. 3 is a relational database having a number of records, each record having a number of fields. Each record comprises a reference data set and the data in each field comprises a separate reference data item.

It is envisaged that database 60 could be implemented in other forms, for example an object oriented database having objects and attributes, in which case a reference data set could be the instance of an object, and the attributes of that instance could be the reference data items.

As shown in FIG. 3, the preferred geographic database 60 contains a number of different reference data items in each reference data set, for example a street number 200, a street name 202, a street type 204, a suburb 206 and a city 208. It is envisaged that where appropriate the geographic database 60 could also include a zip code, post code, state and/or country. Each data set is preferably uniquely identified by a record identifier 210.

The geographic database 60 may also include geographic coordinates. The geographic coordinates shown in FIG. 3 include x coordinates 212, and y coordinates 214 representing the geographic position of each street address as a latitude or longitude, or in a suitable local map co-ordinate system.

The term “street address” as used in the specification includes the geographic address of rural areas, public facilities for example schools and hospitals, and area units for example suburbs and cities. The street address of a large area may, for example, be stored as the centroid of that large area.

It is also envisaged that the geographic database 60 may include data representing postal boxes and rural delivery points.

Reference data sets which do not contain street address data items and/or do not contain geographic data are within the scope of the invention. Data sets which contain these data items are simply one preferred form of data set and serve to illustrate the invention.

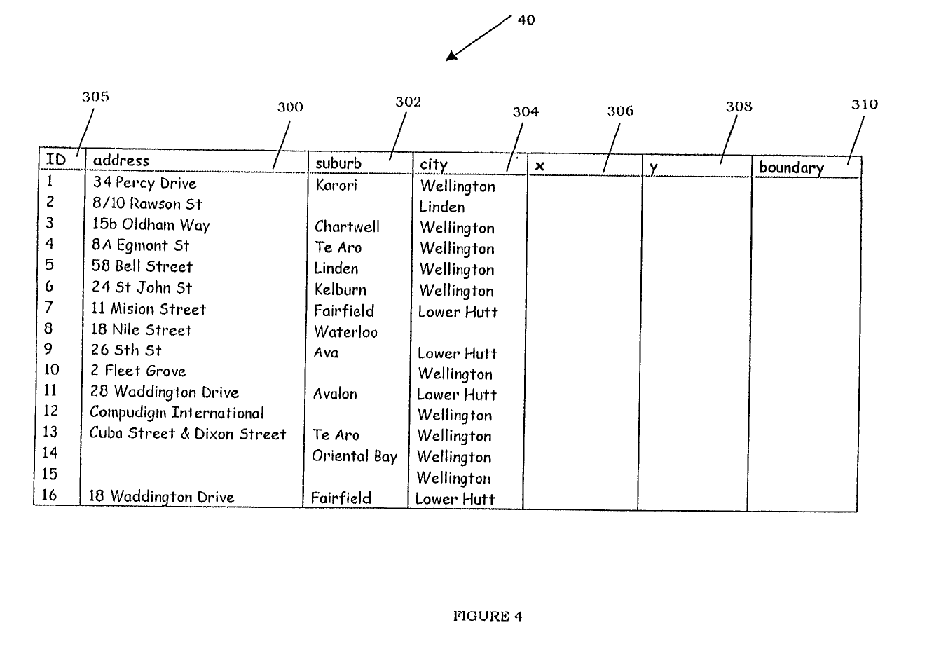

FIG. 4 shows a sample user database in the form of an address database 40. The address database is simply one preferred form of user database. The address database may be obtained from a customer database 50 by extracting only address data from the customer database. In this way the privacy of individual customers in the customer database 50 is protected, especially if the address database 40 is supplied to a third party.

The address database 40 may be implemented in a number of different products, as discussed above with reference to the geographic database 60. These products could include Oracle, Sybase, Informix, DB2, Microsoft SQL server, or Microsoft Access.

The address database shown in FIG. 4 is a relational database having a number of records, each record having a number of fields. Each record comprises a user data set and the data in each field comprises a separate user data item.

The preferred address database 40 contains a number of different user data items in each user data set, for example an address field 300, a suburb field 302 and a city field 304. It is envisaged that where appropriate the address database 40 could also include a zip code, post code, state and/or country. Each data set is preferably uniquely identified by a record identifier 305. It is also envisaged that the address 35 database 40 may include data representing postal boxes and rural delivery points. The address database 40 may also include fields for storing x coordinates 306 and y coordinates 308 representing the geographic position of individual addresses. These coordinates could be represented as a latitude or longitude, or in a suitable local map co-ordinate system.

The x and y coordinates for the address database 40 will normally have null values initially. As the data in the address database 40 is geocoded from the geographic database 60, as will be described below, the x and y coordinates of each address will be stored in the address database 40.

The address database may also include other fields for example a boundary field 310. The system may obtain the boundary for the street address from the geographic database 60 and store the value as a boundary in the address database 40.

The actual structure of address database 40 and geographic database 60 may be normalised to avoid redundant data storage. The databases shown in FIGS. 3 and 4 are simply structured in their current form to illustrate the data sets stored in the databases.

One method of matching the data sets in the user database with data sets in the reference database will now be described. One example involves matching street addresses in the address database 40 with street addresses in the geographic database 60 for geocoding the address database.

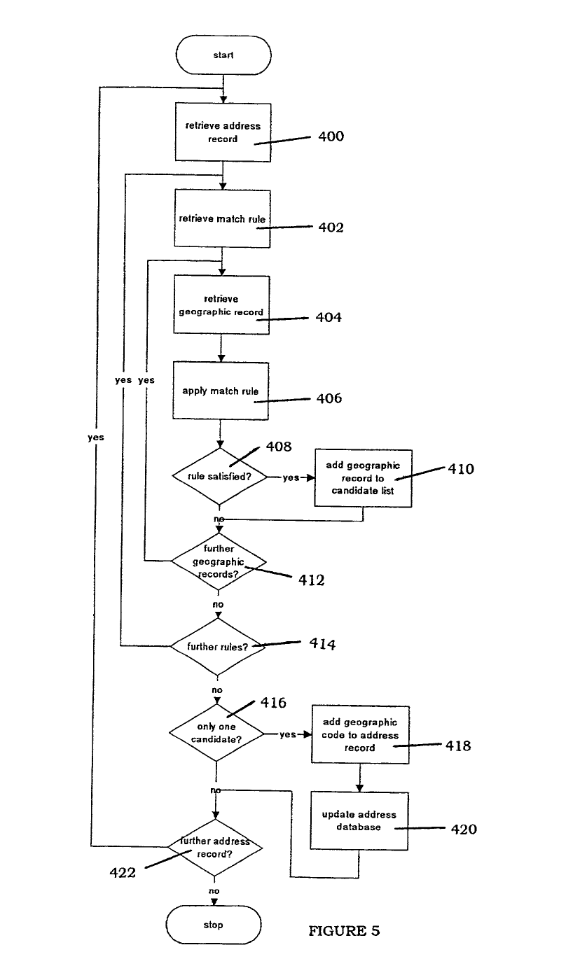

The first stage in geocoding the data is to form an exact or partial match comparison of the data in the address database 40 with the data in the geographic database 60 to compile a list of candidate reference data sets. This match or partial match is described with reference to FIG. 5.

As indicated at 400 in FIG. 5, a user data set in the form of an address record is retrieved from the address database 40. The address record is generally one requiring geographic coordinates.

A match rule is retrieved from rule base 90 as indicated at 402. The match rules are described in more detail below. These match rules permit address records in the address database to be compared with geographic records from the geographic database.

The match rules generally specify one or more data items from the address record and one or more data items from the geographic record to be compared. Preferably the specified data items from the address record are concatenated into a single string, and the single string is searched for individual data items from the geographic record. The rule returns a match or partial match if a significant proportion of data items from the address record match the data items in the geographic record. The system could return a ranking indicating the extent of the match which could also serve as a threshold for the match.

The order in which the data items appear in the concatenated string is generally unimportant, meaning that the system is able to match user data sets where data items are either missing, or specified incorrectly. For example, the suburb data field could be specified in the city data field, or the data in the suburb field may have been transposed with the data in the city field. Matching concatenated data items in this way would overcome these difficulties in the user data.

A reference data set in the form of a geographic record is then retrieved from the geographic database 60 as indicated at 404. As indicated at 406, the match rule retrieved from the rule base is applied to compare the address record from the -address database with the geographic record from the geographic database. As shown at 408, if the match rule is satisfied, the geographic record is added to a candidate list as shown at 410.

As shown at 412, if there is another geographic record in the geographic database to compare with the address record, the next geographic record is retrieved as indicated at 404. If there is another rule in the rule base to apply as indicated at 414, the next match rule is retrieved from the rule base at 402.

If there is only one geographic record at the candidate list as indicated at 416, the geographic coordinates of the geographic record in the candidate list are stored in the address record at 418 and the address database is updated at 420 with the new address record.

As shown as 422, if there is another address record in the address database to geocode, the address record is retrieved from the address database as indicated at 400.

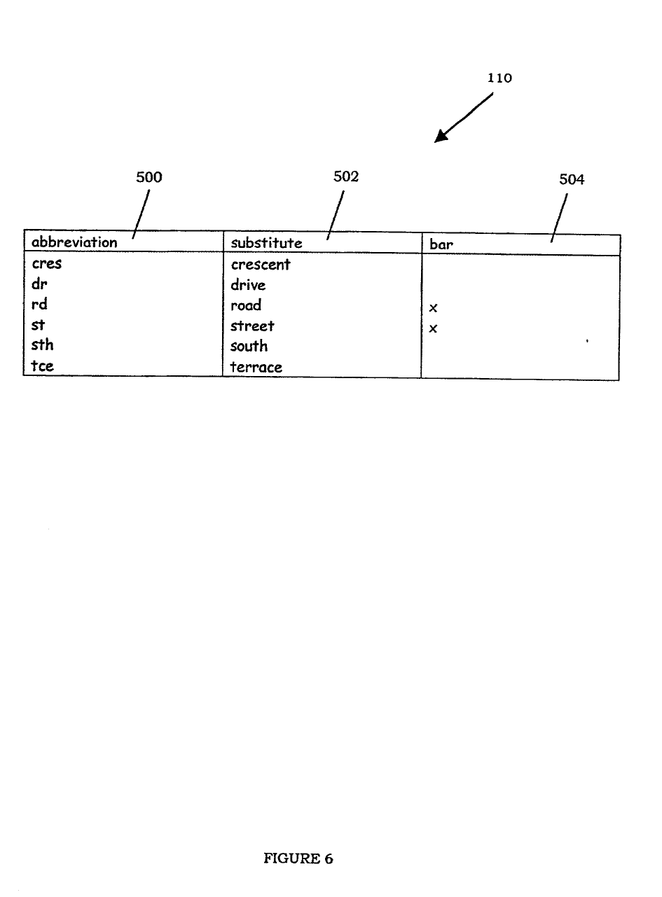

The system 10 may include an abbreviation table 110. A typical abbreviation table is shown in FIG. 6. The preferred abbreviation table 110 includes an abbreviation field 500, a substitute field 502, and a bar field 504. The abbreviation table may have as primary key the abbreviation field.

The abbreviation table includes abbreviations of street names, words within street names, and street types. The abbreviation table may also include abbreviations of suburbs, cities, and where appropriate states and countries. Some abbreviations have more than one substitute. For example the abbreviation “ST” appears twice in the address “24 St John St”. Where an abbreviation has more than one substitute the abbreviation used for street type only is stored in the abbreviation table. Where an abbreviation has more than one substitute, the bar field 504 in the record is given a non-null value to indicate that the abbreviation is used only for street type.

The individual components of the address record may be correlated with the abbreviation table 110. Where there is a match, the data item in the substitute field 502 can be substituted where appropriate for the data item of the address record. It is envisaged that the entire address database could be correlated with the abbreviation table in advance, or the abbreviation table could be invoked for a particular address record where necessary.

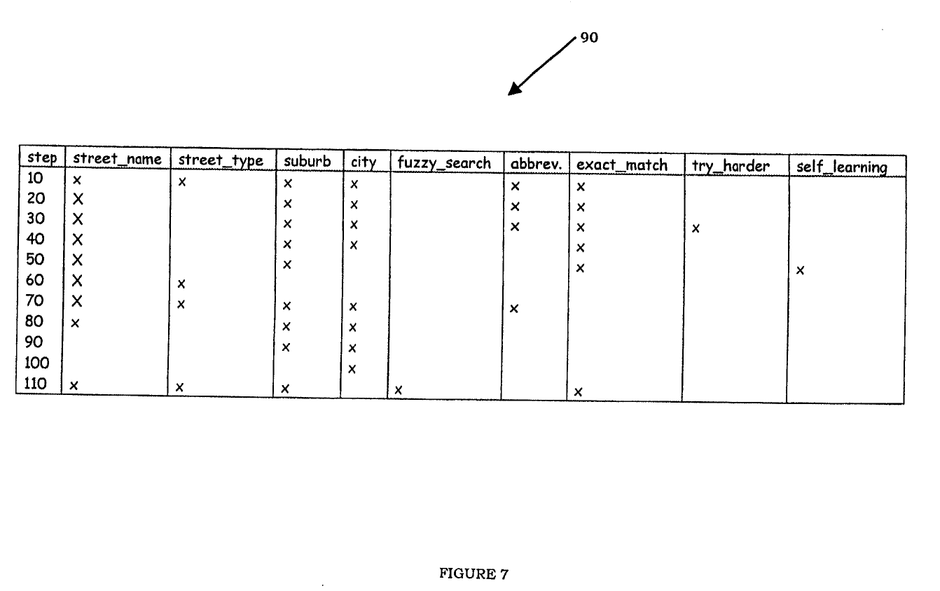

Match rules are preferably stored in a rule base 90. A typical rule base is illustrated in FIG. 7. Preferably the rules are applied in the order determined by rule number. It is envisaged that the rule base 90 may be interfaced to an editor permitting new rules to be added easily, or the priority or other features of existing rules to be amended.

Rule 10 compares street names, street types, suburbs and cities and uses the abbreviation table. If all preconditions are satisfied the rule is satisfied and the geographic record is added to the candidate list. Rule 10 would permit addresses such as “26 5th St” and “24 St John St” to be successfully geocoded.

Rule 20 compares street names, suburbs and cities using the abbreviation table 26 but does not compare street types. This permits addresses in which the street type is either incorrect or is omitted to be successfully geocoded.

Rule 30 applies the same preconditions as rule 20 described above with one addition. Rule 30 invokes the “try-harder” rule. The “try-harder” rule recognises that neighbouring suburbs and cities may often be confused either accidentally or, where one suburb or city is more desirable than a neighbour, deliberately.

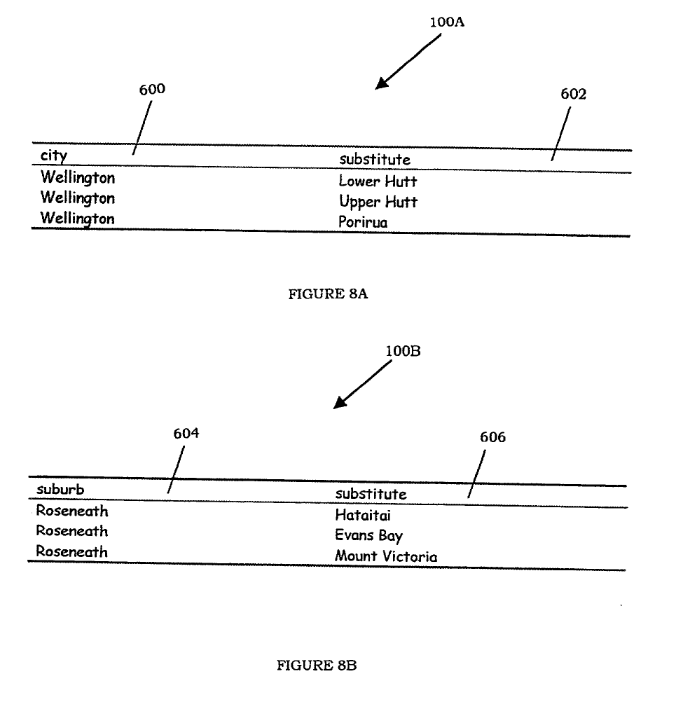

The “try~harder” rule accesses a neighbour table 100. FIG. 8A illustrates a typical neighbour table 100A for cities. The table has a city field 600 and substitute field 602. For example, Lower Hutt, Upper Hutt and Porirua are all within the greater Wellington area and it is not uncommon to specify an address having the city “Wellington” when in fact the address should have the city “Lower Hutt”.

The city is retrieved from the address record and a set of likely candidate cities indexed by city is retrieved from the neighbour table 10A. The city “Wellington” in the address record will recognise Lower Hutt, Upper Hutt and Porirua as candidate cities.

FIG. 8B illustrates a neighbour table 25B for suburbs. The table has a suburb field 604 and substitute field 606. The suburb “Roseneath” in the address record will return from the neighbour table 100B the suburbs Hataitai, Evans Bay and Mt Victoria.

Referring to FIG. 7, Rule 30 permits the address “2 Fleet Grove, Wellington” to be matched with “2 Fleet Grove, Lower Hutt” in the geographic database and successfully geocoded. Similarly, the address “28 Waddington Drive, Avalon” can be successfully matched with “28 Waddington Drive, Fairfield” in the geographic database, and the address successfully geocoded.

Rule 40 compares street names, suburbs, cities but does not use the abbreviation table.

Rule 50 compares street names, and suburbs but does not compare street type and cities. Rule 50 invokes the “self learning rule”. The self learning rule permits the geographic database to learn from the address database, adding records to the geographic database. It will be appreciated that the input of the user may be required before a geographic record is added to the geographic database.

Rule 60 compares just street names and street type. Previously described rules 10, 20, 30, 40 and 50 disable the rule “exact—match”. Rule 60 does not disable “exact—match” and in doing so enables interpolation. The rule exact match is invoked when there is no exact address number in a street. For example, where the address record contains the address “18 Waddington Drive”, and there is no corresponding address in the geographic data, the rule invoked selects the address closest to “18 Waddington Drive”. This may be for example “20 Waddington Drive”. Such interpolation enables the closest address to be derived from one or more neighbouring addresses where there is no exact match.

Rule 70 compares street names, street types, suburbs and cities using the abbreviation table 110 and attempts to match at the closest address point. Rule 80 compares street names, suburbs and cities without using the abbreviation table, and matches at the closest address point. Rule 90 compares suburbs and cities without using the abbreviation table and looks for the closest address point. Rule 100 compares just the city without using the abbreviation table 26 and uses the closest address point.

Rule 110 compares street names, street types, suburbs, with closest address point matching disabled. Rule 110 invokes a “fuzzy-search” which permits a Soundex based address search to locate mis-spelled addresses. The fuzzy search would match “11 Mision Street” in the address database with “Mission Street” in the geographic database, for example.

It will be appreciated that the rule base 24 may be interfaced to an editor which permits the user to alter the order of the rules applied depending on the efficiency needs of the system. In Australia it is necessary to specify a post code in address information. Data sets containing address information are therefore more likely to contain a correct post code in the correct field. A rule matching post codes will be more effective on Australian address data and so this rule could be ordered ahead of a rule which is not so effective on the same data.

In operation the system described above increases the address data which can be geocoded automatically from 60-80% of the data up to 93%. It will be appreciated that automation of geocoding in this way provides a significant time and cost advantage over existing geocoding techniques.

There will still be some instances where the system does not geocode a particular address record. An address record may not have a match and the geographic database or the address record may correspond to more than one candidate in the geographic database. In these circumstances the system may display to the user the address record unable to be geocoded. The correct geocode may then be entered manually by the user. Where there are a number of candidates retrieved from the geographic database, the correct candidate could be selected by the user and the geographic coordinates of the selected record could be added to the address record.

he system may be arranged to run on batches of data or may be arranged to run in real time. Where the system is arranged to run in real time, the system could interact with the user to entertain validation of a geographic address where necessary. Where the system runs on batched data, the address records for which no geographic coordinates can be found could be stored in memory 120 and presented to a user at an appropriate time for validation.

In a further preferred form of the invention, the address database 40 and geographic database 60 include one or more universal record locators (URLs), each URL specifying the location of a hypertext mark-up language (HTML) document. Preferably each URL specifies the homepage of a particular company, which is the HTML document most useful to an Internet user to traverse a company's website Geographic coordinates could be associated with the URLs in the same way as geographic coordinates are associated with physical address data as described above. URLs in the address database could then be geocoded by matching to URLs in the geographic database.

It is envisaged that the rule base may be substituted or supplemented with other techniques for partial matches. One example includes a neural network trained to compare address records with geographic records and return a value representing either a match/partial match or otherwise returning a value representing no match.

It will be appreciated that the invention is particularly suitable for geocoding address data. It is envisaged that the same invention could be applied to the task of matching any data set in one database to a reference data set in another database.

Many postal organisations offer bulk mail discounts, provided that the delivery address of the mail item is of a pre-specified height, length and thickness, in a predefined font, type size, with suitable word spacing and in a standard address format. Such a format could comprise an OCR (Optical Character Recognition) machine template which is particularly suitable for automated scanning and processing by the mail organisation.

One form of the invention could be arranged to retrieve geocoded address data from the address database 40 or customer database 50 and generate mail addresses in a format compatible with a postal organisation's automated bulk mail processing hence qualifying for bulk mail discounts.

The foregoing describes the invention including preferred forms thereof. Alterations and modifications as will be obvious to those skilled in the art are intended to be incorporated within the scope hereof, as defined by the accompanying claims.

1. A method of matching data sets comprising the steps of:
maintaining one or more user data sets in a user data memory, each user data set comprising one or more user data items;
maintaining one or more reference data sets in a reference data memory, each reference data set comprising one or more reference data items;
retrieving a user data set from the user data memory;
retrieving one or more reference data sets from the reference data memory, each of the retrieved reference data sets matching or partially matching the user data set; and
compiling a list of candidate reference data sets from the retrieved reference data set(s).

2. A method as claimed in claim 1 further comprising the step of selecting one or more reference data items within a reference data set, a reference data set matching or partially matching a user data set if all selected reference data items of the reference data set are members of the user data set.

3. A method as claimed in claim I or claim 2 further comprising the steps of selecting one or more user data items within the user data set; and substituting the selected user data items with further data items.

4. A method as claimed in any one of the preceding claims wherein both the user data items and the reference data items comprise character strings.

5. A method as claimed in claim 4 further comprising the steps of concatenating the user data items into a single string; and retrieving the reference data sets from the reference data memory based on string comparisons.

6. A method as claimed in any one of the preceding claims further comprising the step of storing further reference data sets in the reference data memory.

7. A method as claimed in any one of the preceding claims further comprising the steps of:
maintaining one or more rules in a rule base memory, each rule arranged to take as input a user data set and a reference data set, returning a match where the user data set matches or partially matches the reference data set;
retrieving successive rules from the rule base memory; and
retrieving the reference data sets from the reference data memory based on the retrieved rules.

8. A method as claimed in any one of the preceding claims further comprising the steps of displaying to a user the list of candidate reference data sets where the list comprises two or more candidates; and providing means for a user to select the correct candidate from the list.

9. A method as claimed in any one of the preceding claims further comprising the step of updating the user data set with one or more reference data items from the candidate reference data set(s).

10. A method as claimed in any one of the preceding claims wherein the user data sets and the reference data sets include data sets representing street addresses.

11. A method as claimed in any one of the preceding claims wherein the user data sets and the reference data sets include data sets representing postal box addresses.

12. A method as claimed in any one of the preceding claims wherein the user data sets and the reference data sets include data sets representing electronic and/or Internet addresses.

13. A method as claimed in any one of claims 10 to 12 wherein the reference data sets include data sets representing geographic coordinates of street addresses, postal box addresses, electronic and/or Internet addresses.

14. A data set matching system comprising:
one or more user data sets maintained in a user data memory, each user data set comprising one or more user data items;
one or more reference data sets maintained in a reference data memory, each reference data set comprising one or more reference data items;
user data set retrieval means arranged to retrieve a user data set from the user data memory;
reference data set retrieval means arranged to retrieve one or more reference data sets from the reference data memory, each of the retrieved reference data sets matching or partially matching the user data set; and
compiling means arranged to compile a list of candidate reference data sets from the retrieved reference data set(s).

15. A system as claimed in claim 14 wherein the reference data set retrieval means is arranged to select one or more reference data items within a reference data set, a reference data set matching or partially matching a user data set if all selected reference data items of the reference data set are members of the user data set.

16. A system as claimed in claim 14 or claim 15 wherein the reference data set retrieval means is further arranged to select one or more user data items within the user data set; and substitute the selected user data items with further data items.

17. A system as claimed in any one of claims 14 to 16 wherein both the user data items and the reference data items comprise character strings.

18. A system as claimed in claim 17 further comprising means for concatenating the user data items into a single string; the reference data set retrieval means arranged retrieve the reference data sets from the reference data memory based on strong comparisons.

19. A system as claimed in any one of claims 14 to 18 further arranged to store further reference data sets in the reference data memory.

20. A system as claimed in any one of claims 14 to 19 further comprising.
one or more rules maintained in a rule base memory, each rule arranged to take as input a user data set and a reference data set, returning a match where the user data set matches or partially matches the reference data set; and
rule retrieval means arranged to retrieve successive rules from the rule base memory;
wherein the reference data set retrieval means is arranged to retrieve the reference data sets from the reference data memory based on the retrieved rules.

21. A method as claimed in any one of claims 14 to 20 further comprising display means arranged to display to a user the list of candidate reference data sets where the list comprises two or more candidates; and selection means arranged to enable a user to select the correct candidate from the list.

22. A system as claimed in any one of claims 14 to 21 further comprising updating means arranged to update the user data set with one or more reference data items from the candidate reference data set(s).

23. A system as claimed in any one of claims 14 to 22 wherein the user data sets and the reference data sets include data sets representing street addresses.

24. A system as claimed in any one of claims 14 to 23 wherein the user data sets and the reference data sets include data sets representing postal box addresses.

25. A system as claimed in any one of claims 14 to 24 wherein the user data sets and the reference data sets include data sets representing electronic and/or Internet addresses.

26. A system as claimed in any one of claims 23 to 25 wherein the reference data sets include data sets representing geographic coordinates of street addresses, postal box addresses, electronic and/or Internet addresses.

27. A data set matching computer program comprising:
one or more user data sets maintained in a user data memory, each user data set comprising one or more user data items;
one or more reference data sets maintained in a reference data memory, each reference data set comprising one or more reference data items;
user data set retrieval means arranged to retrieve a user data set from the user data memory;
reference data set retrieval means arranged to retrieve one or more reference data sets from the reference data memory, each of the retrieved reference data sets matching or partially matching the user data set; and
compiling means arranged to compile a list of candidate reference data sets from the retrieved reference data set(s).

28. A computer program as claimed in claim 27 wherein the reference data set retrieval means is arranged to select one or more reference data items within a reference data set, a reference data set matching or partially matching a user data set if all selected reference data items of the reference data set are members of the user data set.

29. A computer program as claimed in claim 27 or claim 28 wherein the reference data set retrieval means is further arranged to select one or more user data items within the user data set; and substitute the selected user data items with further data items.

30. A computer program as claimed in any one of claims 27 to 29 wherein both the user data items and the reference data items comprise character strings.

31. A computer program as claimed in claim 30 further comprising means for concatenating the user data items into a single string; the reference data set retrieval means arranged retrieve the reference data sets from the reference data memory based on string comparisons.

32. A computer program as claimed in any one of claims 27 to 31 further arranged to store further reference data sets in the reference data memory.

33. A computer program as claimed in any one of claims 27 to 32 further comprising:
one or more rules maintained in a rule base memory, each rule arranged to take as input a user data set and a reference data set, returning a match where the user data set matches or partially matches the reference data set; and
rule retrieval means arranged to retrieve successive rules from the rule base memory;
wherein the reference data set retrieval means is arranged to retrieve the reference data sets from the reference data memory based on the retrieved rules.

34. A computer program as claimed in any one of claims 27 to 33 further comprising display means arranged to display to a user the list of candidate reference data sets where the list comprises two or more candidates; and selection means arranged to enable a user to select the correct candidate from the list.

35. A computer program as claimed in any one of claims 27 to 34 further comprising updating means arranged to update the user data set with one or more reference data items from the candidate reference data set(s).

36. A computer program as claimed in any one of claims 27 to 35 wherein the user data sets and the reference data sets include data sets representing street addresses.

37. A computer program as claimed in any one of claims 27 to 36 wherein the user data sets and the reference data sets include data sets representing postal box addresses.

38. A computer program as claimed in any one of claims 27 to 37 wherein the user data sets and the reference data sets include data sets representing electronic and/or Internet addresses.

39. A computer program as claimed in any one of claims 36 to 38 wherein the reference data sets include data sets representing geographic coordinates of street addresses, postal box addresses, electronic and/or Internet addresses.

40. A computer program as claimed in any one of claims 27 to 39 embodied on a computer readable medium.
